(19) United States
(12) Patent Application Publication
(10) Pub. No.: US 2009/0167062 A1
(43) Pub. Date: Jul. 2, 2009

(54) Folding Canopy With Drainage Feature

(75) Inventors: Charles Greif, Aiken, SC (US); Leo Watts, Aiken, SC (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/966,107

(22) Filed: Dec. 28, 2007

(51) Int. Cl. B62D 25/07

(52) U.S. Cl. 296/213; 296/210

(57) ABSTRACT

A golf car can include a folding canopy system that can be moved from a raised operable position to a lowered shipping position. In a shipping position, the canopy has a lower overall height than in the operable position. In the shipping position, the seating area of the golf car is still accessible to allow the golf car to be driven onto and off of the transportation container with the canopy in the shipping position. Upon removal from the transportation container, the canopy can be moved to its raised position and secured in that position. A roof canopy can have a plurality of channels that direct captured water to a collection basin. The collection basin can communicate with a drainage member that drains the water from the canopy to a lower portion of the golf car and releases the captured rain in a desirable location.

### TECHNICAL FIELD

The present disclosure relates to golf cars and, more specifically, to a folding canopy and drainage features associated with the canopy.

### BACKGROUND

The statements in this section merely provide background information related to the present disclosure and may not constitute prior art.

Golf cars provide transportation to golfers around a golf course. Many golf cars are equipped with a roof canopy. The roof canopy is coupled to the golf car with a pair of upwardly extending front struts arranged on a front portion of the golf car and a pair of upwardly extending rear struts arranged on a rear portion of the golf car.

At the factory, the golf cars are assembled then shipped without the canopy and the associated struts secured thereto. The golf cars can be shipped in an enclosed trailer with one golf car stacked above another. Due to the space limitations of the shipping container, the golf cars cannot be stacked two high when the canopy and associated struts are attached thereto. Thus, upon delivery the canopy and struts are assembled to the golf car at the delivery location. This can result in inferior performance (e.g., rattles, loose connections, etc.) due to improper installation. Additionally, the attachment of the canopy and associated struts at the delivery location can increase the cost and require a skilled worker to perform the same.

The roof canopy can collect water when the golf car is operated during a raining condition and during washing. Typically, the water runs off the canopy in the rear or in an otherwise uncontrolled manner. The water run-off from the canopy can cause water to be directed onto the golf clubs carried on the golf car or result in other undesirable run-off locations.

### SUMMARY

According to the present teachings, a golf car can include a folding canopy system that can be moved from a raised operable position to a lowered shipping position. The canopy is coupled to the golf car in both the raised and lowered positions. When in a shipping position, the canopy has a lower overall height than in the operable position. In the shipping position, the seating area of the golf car is still accessible to allow the golf car to be driven onto and off of the transportation container with the canopy in the shipping position. Upon removal from the shipping container, the canopy can be moved to its raised position and secured in that position.

According to the present disclosure, a roof canopy can have a plurality of channels that capture water thereon and direct the captured water to a single collection basin. The collection basin can communicate with a drainage member that drains the water from the canopy to a lower portion of the golf car and releases the captured water in a desirable location.

According to the present disclosure, a roof canopy can be coupled to a golf car with front and rear strut members. A portion of at least one of the strut members can extend along a bottom surface of the canopy and be spaced apart therefrom and form a grab handle.

Further areas of applicability of the present teachings will become apparent from the description provided herein. It should be understood that the description and specific examples are intended for purposes of illustration only and are not intended to limit the scope of the present teachings.

### DRAWINGS

FIG. 1 is a side plan view of a golf car according to the present teachings with the canopy in the raised operable position;

FIG. 2 is a side plan view of the golf car of FIG. 1 with the canopy in the lowered shipping position;

FIG. 3 is a front plane view of the golf car of FIG. 2 showing the folding of the front struts;

FIG. 4 is a fragmented perspective view of the golf car of FIG. 2 showing the location of the rear struts when the roof is in the lowered position;

FIGS. 5A and 5B are fragmented cross-sectional views of the front strut and hinge assembly in the raised and lowered positions, respectively;

FIG. 6 is a fragmented perspective view of the rear strut attachment to the golf car when the canopy is in the raised position;

FIG. 7 is a fragmented perspective view of the attachment of the rear struts to the canopy;

FIG. 8 is a fragmented perspective view of the attachment of the front struts to the canopy;

FIG. 9 is a fragmented cross-sectional view of the attachment of the front struts to the canopy along line 9-9 of FIG. 8;

FIG. 10 is a top plan view of the canopy showing the contouring and preferential direction of water drainage thereon;

FIG. 11 is a perspective view of the top of the canopy; and

FIG. 12 is a fragmented perspective view of the bottom surface of a front portion of the canopy with one of the front struts attached thereto and the other front strut shown in assembly view.

### DETAILED DESCRIPTION

The following description is merely exemplary in nature and is not intended to limit the present teachings, applications, or uses.

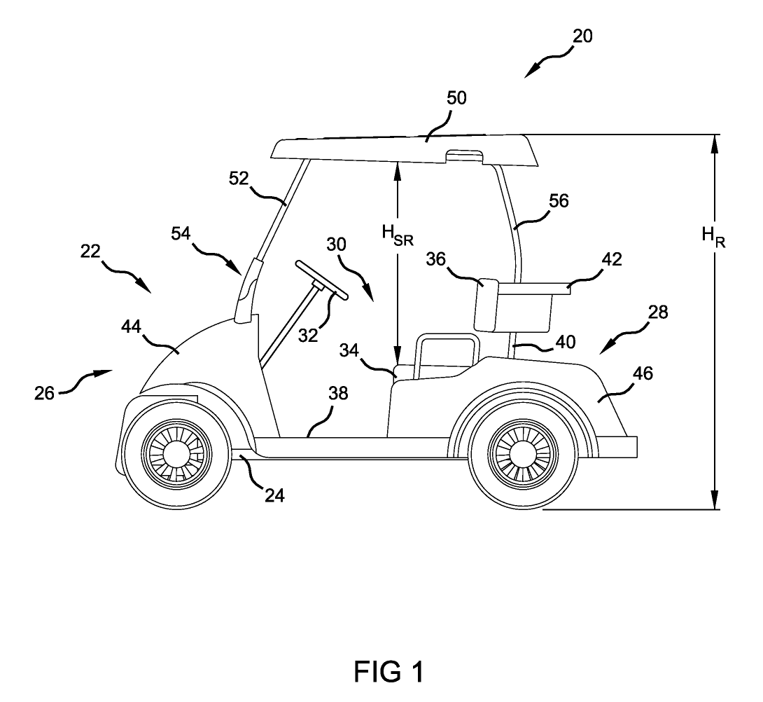

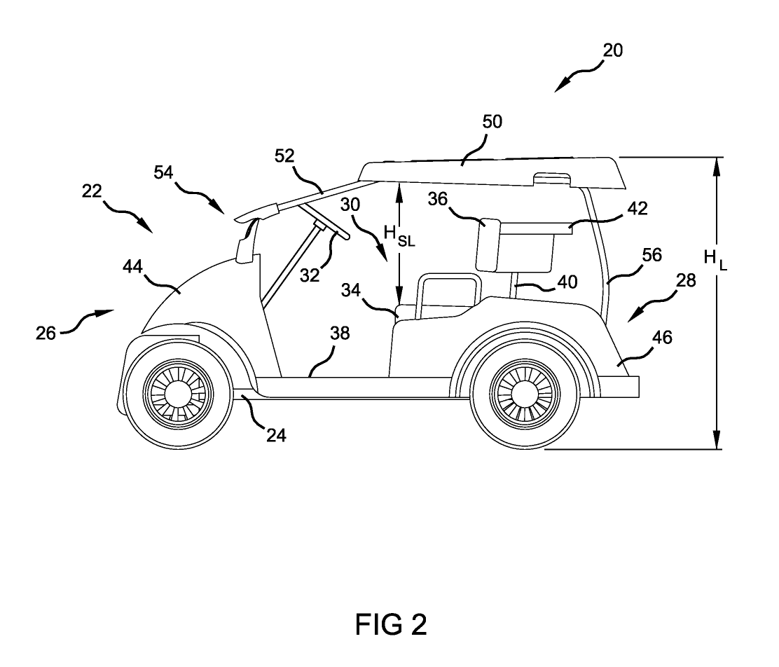

With initial reference to FIGS. 1 and 2, a folding canopy system in accordance with the present teachings is shown and identified generally at reference 20. Canopy system 20 is illustrated operably connected to an exemplary golf car 22. It should be appreciated that golf car 22 is merely exemplary and that canopy system 20 can be adapted for use with other golf car configurations. Furthermore, canopy system 20 described herein is not limited for use with golf cars and can also be used with other vehicles such as, but not limited to, utility vehicles, lawn mowers, other turf-care vehicles, passenger shuttle vehicles, and the like.

Referring to FIGS. 1-4, golf car 22 can include a frame 24 having a front end 26 and a rear end 28 mounted thereon. Rear end 28 can include a golf bag storage area 29. A passenger seating area 30 is centrally located in golf car 22. Passenger seating area 30 can include a steering wheel 32, accelerator and brake pedals (not shown), a seat 34, a seatback 36 and a floor portion 38. Seatback 36 can be supported from frame 24 with a support member 40 coupled to both frame 24 and seatback 36. A sweater basket 42 can be attached to support member 40 and be disposed rearward of seatback 36. Sweater basket 42 can include features that facilitate the retaining of golf clubs within storage area 29. Additionally, golf car 22 can include a front cowl 44 and rear body panels 46 to provide a desired aesthetic appearance for golf car 22.

Canopy system 20 includes a canopy 50 that is configured to extend above seating area 30 to provide protection from the sun and the rain. A pair of front strut members 52 is coupled to canopy 50 at one end thereof while the other ends of front strut members 52 are pivotably coupled to frame 24 with hinge assemblies 54. A pair of rear strut members 56 supports the rear portion of canopy 50. One end of each rear strut member 56 is attached to the rear portion of canopy 50 while the other ends of rear strut members 56 are attached to support member 40 when canopy system 20 is in the raised operable position, as shown in FIG. 1.

Canopy system 20 allows canopy 50 to be moved between a raised and operable position, as shown in FIG. 1, to a lowered (folded) shipping position, as shown in FIG. 2. In the raised position, canopy 50 has a raised height H_{R} and seating area 30 has a raised seating H_{SR}. When canopy system 20 is in the lowered position, canopy 50 has a lowered height H_{L} while seating area 30 has a lowered seating height H_{SL}. The specific raised and lowered heights H_{R}, H_{L} of canopy 50 can vary based upon the desired heights, the configuration of the particular golf car on which canopy system 20 is utilized, and other considerations. Additionally, the specific raised and lowered seating heights H_{SR}, H_{SL} can also vary depending upon the design and configuration of canopy system 20 and the particular configuration of the golf car upon which it is utilized. For example, H_{R} can be about 67 to about 71 inches; H_{L} can be about 49 to about 54 inches; H_{SR} can be about 52 to about 56 inches; and H_{SL} can be about 22 to about 26 inches, by way of non-limiting example.

The lowered height H_{L} can be selected to allow for a golf car 22 having canopy system 20 to have a height that facilitates the shipping of the golf car 22. For example, in some transport containers, the golf cars can be shipped two high with one stacked above the other. In this situation, the overall interior height of the storage container can dictate the maximum height of the golf cars to enable them to be stacked two high within the transport container. Canopy system 20 can be designed to have a height H_{L} that allows the golf cars to be stacked two high within the transport container. The stacking of the golf cars two high can reduce the shipping costs associated with the golf cars and provide for a more efficient means of transport.

Additionally, the seating height of canopy system 20 can be designed to facilitate the driving of golf car 22 by a passenger seated in seating area 30. In particular, during the loading of golf car 22 onto a transport container, the lowered seating height H_{SL} can be selected to still enable a person to sit in seating area 30 and drive golf car 22 onto the transport container. Maintaining the lowered seating height H_{SL} at a height that allows an individual to still drive golf car 22 can facilitate the loading and unloading of golf cars 22 when canopy system 20 is in the lowered position. This capability can enable more efficient loading and unloading of golf car 22 and reduce the cost associated with transporting same.

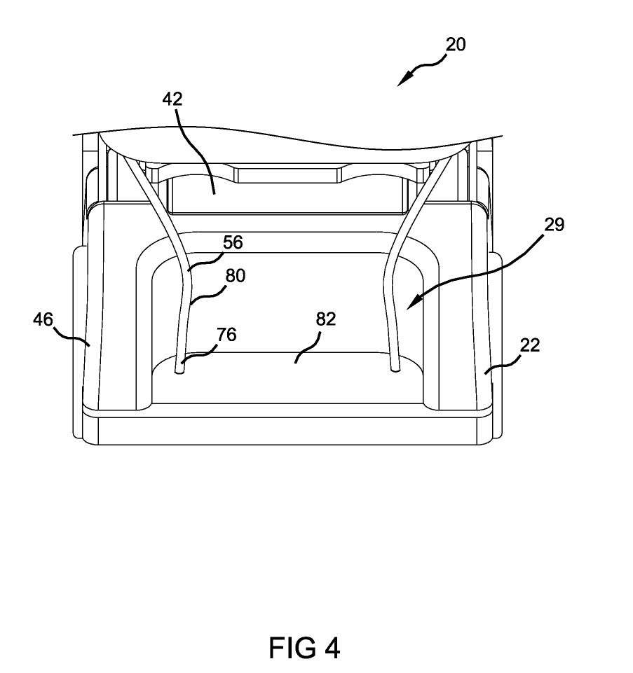

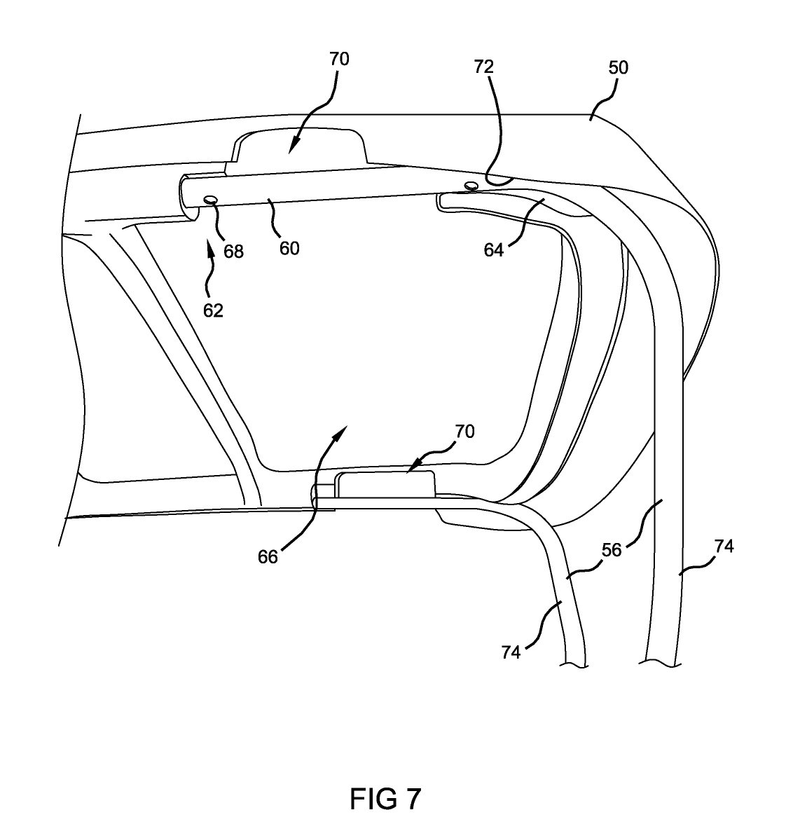

Referring now to FIGS. 4, 6 and 7, details of the connection of rear strut members 56 to canopy 50 and golf car 22 are shown. Rear strut members 56 include a generally horizontal portion 60 adjacent end 62. Horizontal portion 60 fits within complementary recesses 64 in the bottom surface 66 of canopy 50. Recesses 64 extend longitudinally along bottom surface 66 adjacent the periphery of canopy 50. A pair of fasteners 68 with rubber sealing members secures each rear strut member 56 to canopy 50. The fasteners can extend through canopy 50 and the sealing member can prevent water leakage through the openings in canopy 50 through which the fasteners extend. Canopy 50 includes a hand-grab recess 70 that provides a cavity around a section of horizontal portion 60 of each rear strut member 56. Recess 70 allows an occupant of seating area 30 to grasp horizontal portion 60 of rear strut members 56, as needed. The ability to grasp horizontal portion 60 of rear strut members 56 can facilitate entering and exiting seating area 30 and riding in golf car 22 as it is driven. The ability to directly grab rear strut member 56 facilitates the transfer of weight imposed thereon by a user directly to frame 24 through rear strut members 56. The cavity formed by recess 70 is inboard of the peripheral lip 72 of canopy 50. As a result, the hand of a person who grasps horizontal portion 60 is within the protective confines of canopy 50.

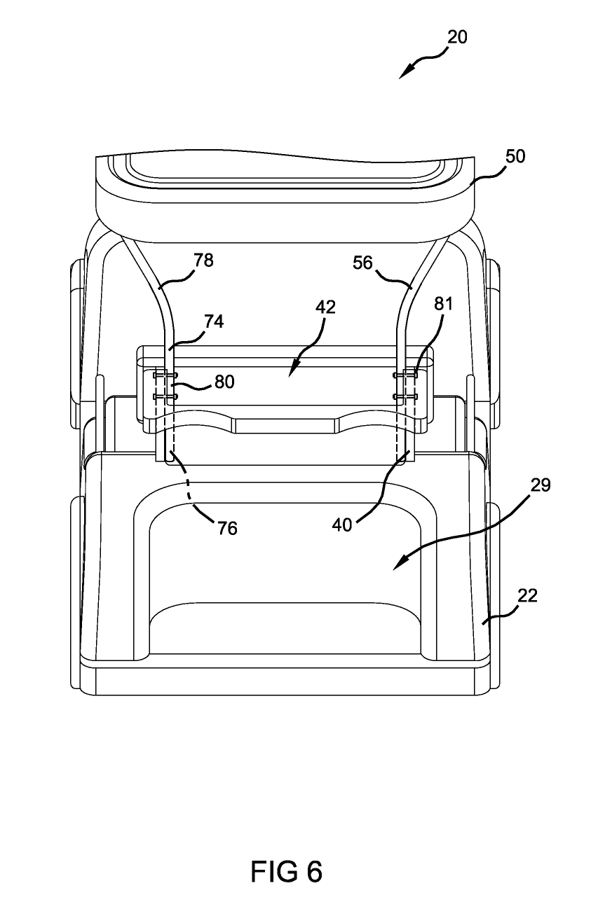

Rear strut members 56 can include a vertical portion 74 that extends to lower end 76. In some configurations, such as that shown herein, vertical portion 74 includes a transversely tapering section 78 and a non-tapering section 80. The specific configuration of vertical portion 74 can be varied depending upon the desired connecting of end 76 of rear strut members 56 to frame 24. In this particular application, straight sections 80 adjacent end 76 are fastened to different portions of support member 40 when in the raised operative position, as shown in FIGS. 1 and 6. Fasteners 81, such as bolts, screws, and the like can be used to releasably secure straight sections 80 to support member 40.

When canopy system 20 is in the lowered position, straight sections 80 of each rear strut member 56 are uncoupled from support member 40 and ends 76 are disposed in storage area 29. Specifically, ends 76 rest on floor 82 of storage area 29. The use of releasable fasteners 81 to secure rear strut members 56 to support member 40 facilitates the easy attaching of rear strut members 56 therefrom to change canopy system 20 between the raised and lowered positions, as described below. Additionally, horizontal portion 60 of rear strut members 56 are not disconnected from the rear portion of canopy 50 when moving canopy system 20 between the raised and lowered positions.

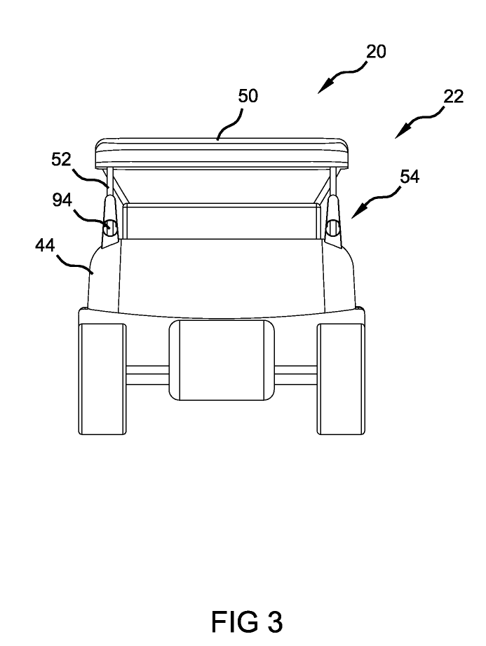

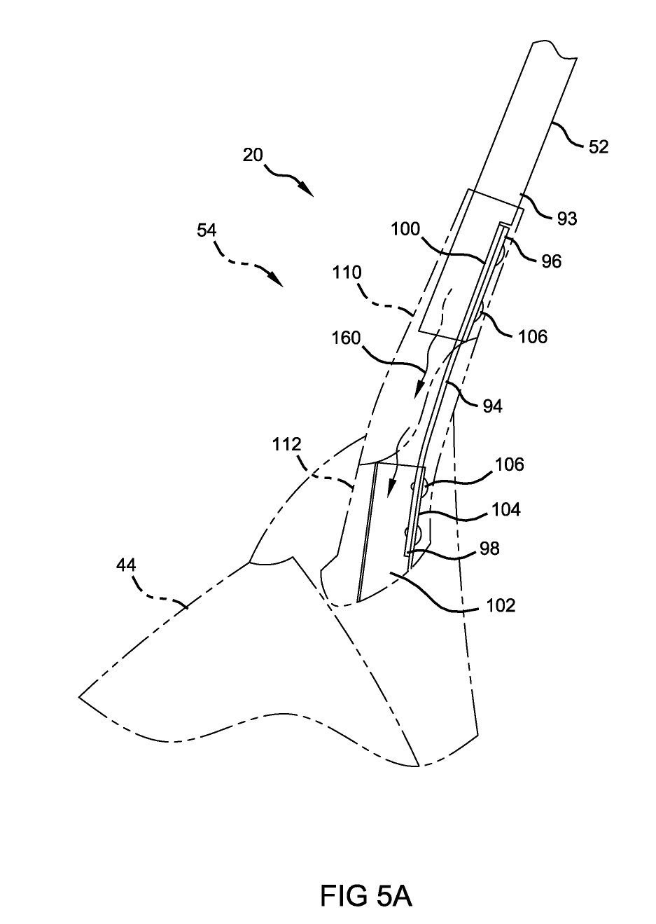

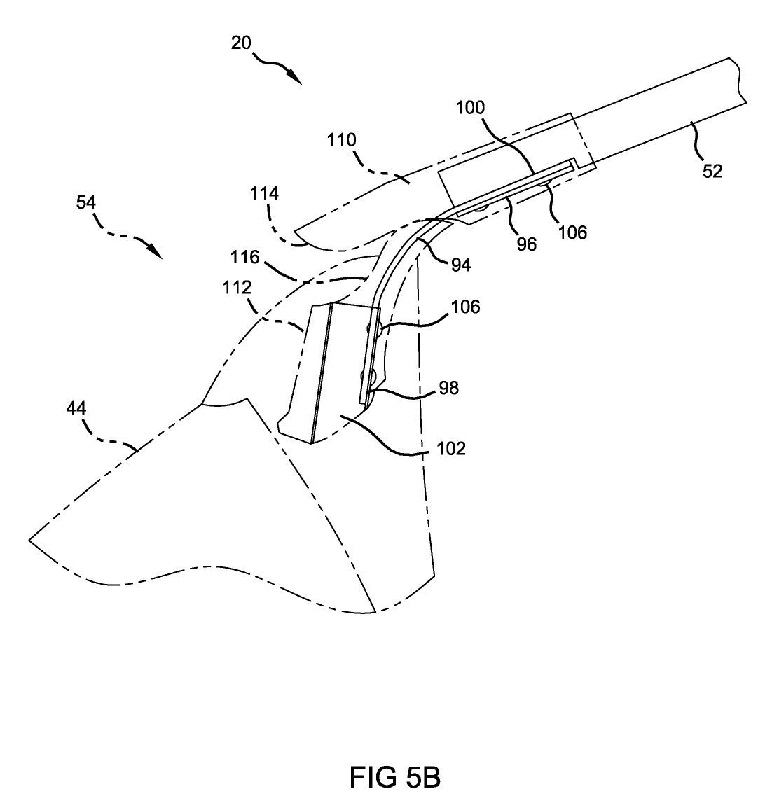

Referring now to FIGS. 3, 5, 8 and 12, details of front strut members 52 and their attachment to canopy 50 and golf car 22 are illustrated. Front strut members 52 each include a lower end 90 that is coupled to frame 24 and an upper end 92 that is coupled to canopy 50. Front strut members 52 are tubular members with lower ends 90 including a spring member 94 extending therefrom. Spring member 94 is bendable, as shown in FIG. 5B, such that front strut members 52 can be folded to lower canopy 50, as described below. Spring member 94 can be a generally rectangular band with opposite first and second ends 96, 98. Spring member 94 can be relatively flat. First end 96 of spring member 94 is attached to front strut member 52 adjacent lower end 90. Lower end 90 can include a flattened section 100 that is complementary to the first end portion 96 of spring member 94. Second end 98 of spring member 94 is coupled to a framing member 102 which can be rigidly attached to frame 24. Framing member 102 can be rectangular and can include a flat section 104 that is complementary to the second end portion 98 of spring member 94. First and second end portions 96, 98 can be attached to front strut member 52 and framing member 102 in a variety of manners. For example, fasteners 106 can be used to attach spring member 94 to front strut member 52 and framing member 102. Fasteners 106 can be rivets, screws, nuts and bolts, and the like. Additionally, it should be appreciated that other fastening methods can be employed, such as welding, brazing, and the like, by way of non-limiting example.

Spring member 94 can be carbon steel and can have a spring temper. Spring member 94 is operable to bend or flex to allow canopy system 20 to move canopy 50 between the raised and lowered position. Front strut member 52 and framing member 102 can be tempered carbon steel.

Hinge assembly 54 extends around lower end 90, spring member 94, and a portion of framing member 102. Hinge assembly 54 includes an upper member 110 and a lower member 112. Lower end 90 of front strut member 52 is disposed within upper member 110, while framing member 102 is disposed within lower member 112. Upper and lower members 110,112 can be secured to front strut member 52 and framing member 102 in a variety of manners. For example, adhesive, fasteners, and the like, by way of non-limiting example, can be utilized to secure upper and lower members 110, 112 to front strut member 52 and framing member 110. Upper and lower members 110, 112 each include a mating surface 114, 116, respectively, that engages with one another when canopy 50 is in the raised operable position, as shown in FIG. 5A. When canopy 50 is moved between the raised and lowered positions, mating surfaces 114, 116 separate and may slide over one another to provide additional support during the moving process. Mating surfaces 114, 116 can extend vertically as they extend horizontally across upper and lower members 110, 112. Hinge assemblies 54 can be polymeric. Lower member 112 can extend through front cowl 44 to provide a desired aesthetic appearance.

Thus, the coupling of front strut members 52 to spring members 94 and therethrough to framing members 102, allows canopy 50 to be moved between the raised and lowered positions. Hinge assembly 54 can provide a desired aesthetic appearance and can protect and encase lower end 90, spring member 94, and the upper portions of framing member 102. Front strut members 52 are not detached from framing member 102 and, thus, from frame 24 when moving between the raised and lowered positions.

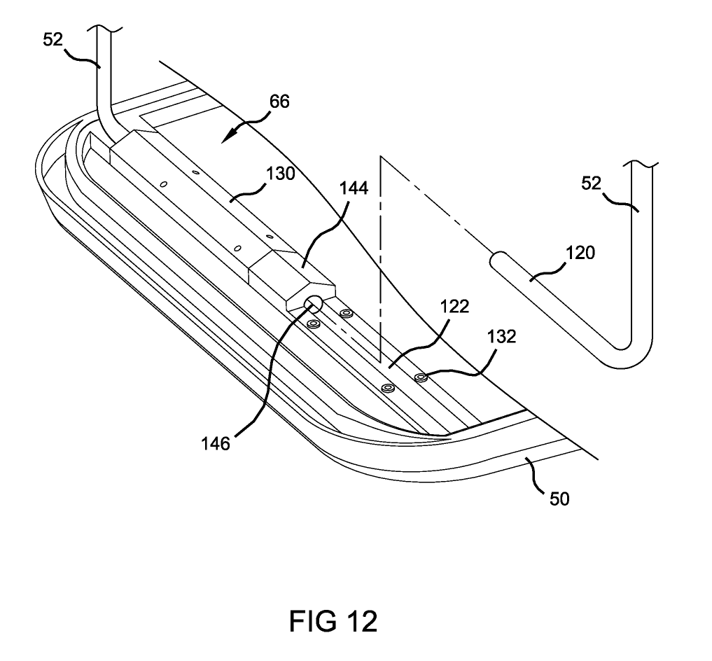

Front strut members 52 include a generally horizontal portion 120 adjacent upper end 92. Bottom surface 66 of canopy 50 includes a pair of recesses 122 (only one shown in FIG. 12) adjacent a front end thereof. Recesses 122 are complementary to and receive horizontal portions 120 of front strut members 52. Horizontal portions 120 are rotatable within recesses 122 to allow canopy 50 to move between the raised and stowed positions. A pair of cover members 130 can be attached to bottom surface 66 to cover recesses 122 and secure horizontal portions 120 of front strut members 52 to canopy 50. Bottom surface 66 can include a plurality of threaded inserts 132 that facilitate the attachment of cover members 130 to bottom surface 66 of canopy 50 with threaded fasteners. It should be appreciated, however, that other fastening systems can be utilized to attach cover members 130 to canopy 50 and secure front strut members 52 thereto.

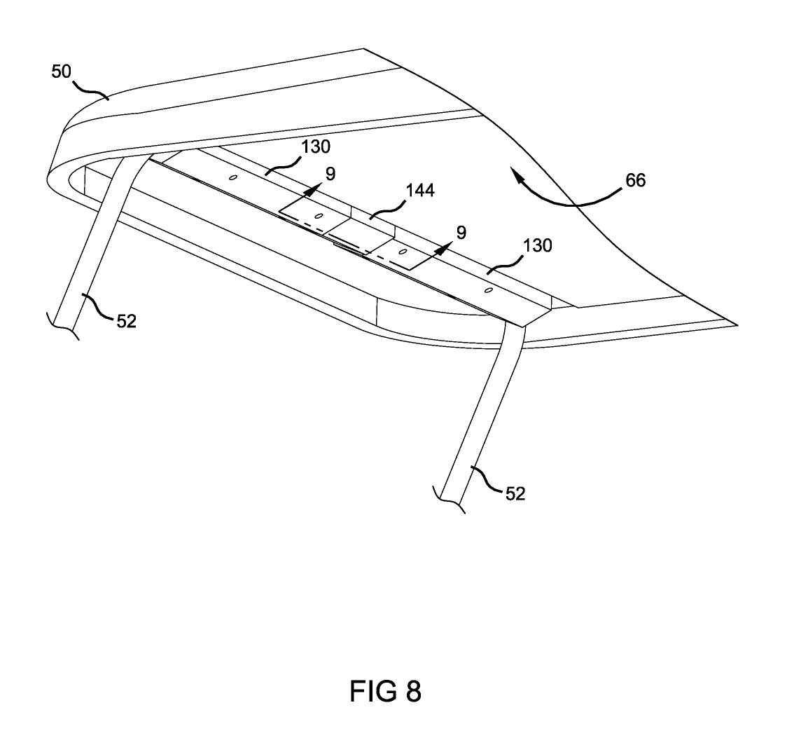

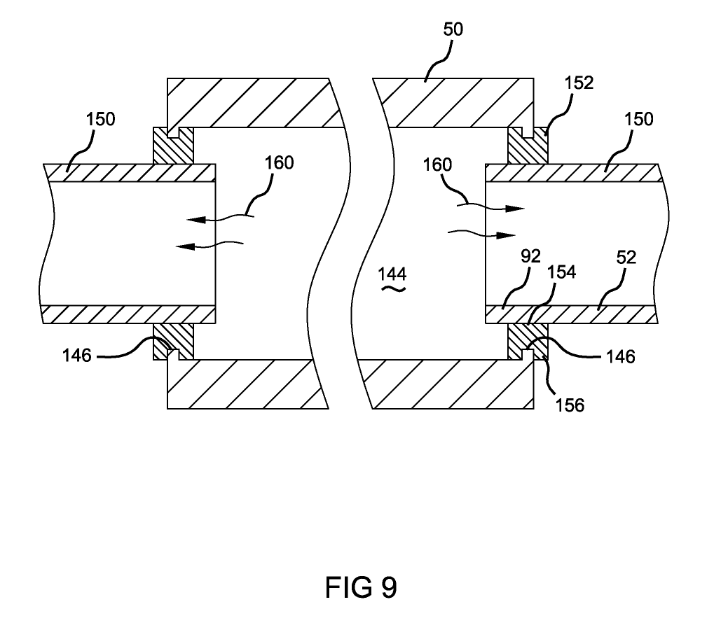

Referring now to FIGS. 8-12, canopy system 20 includes a water management system that facilitates the collection of water from the top surface 140 and routes the captured water through front strut members 52 to be discharged in a lower portion of golf car 22, as shown in FIG. 5A. Specifically, canopy 50 includes a collection basin 144 that water on top surface 140 is directed to. Basin 144 is located between recesses 122 and has a pair of transverse openings 146 (FIGS. 9 and 12) that allow captured water to be directed into the internal cavity 150 of front strut members 52. A sealing member 152, such as an elastomeric grommet by way of non-limiting example, has a central opening 154 that receives upper end 92 of front strut member 52. The exterior surface 156 of sealing member 152 engages with the peripheral edge of opening 146. The engagement of sealing member 152 with opening 146 and front strut member 52 can provide a fluid-tight seal such that water collected in basin 144 is directed into cavity 150 of front strut members 52, as indicated by the wavy lines 160. Sealing member 152 allows front strut members 52 to be rotated relative to basin 144 when canopy 50 is moving between the raised and stowed position.

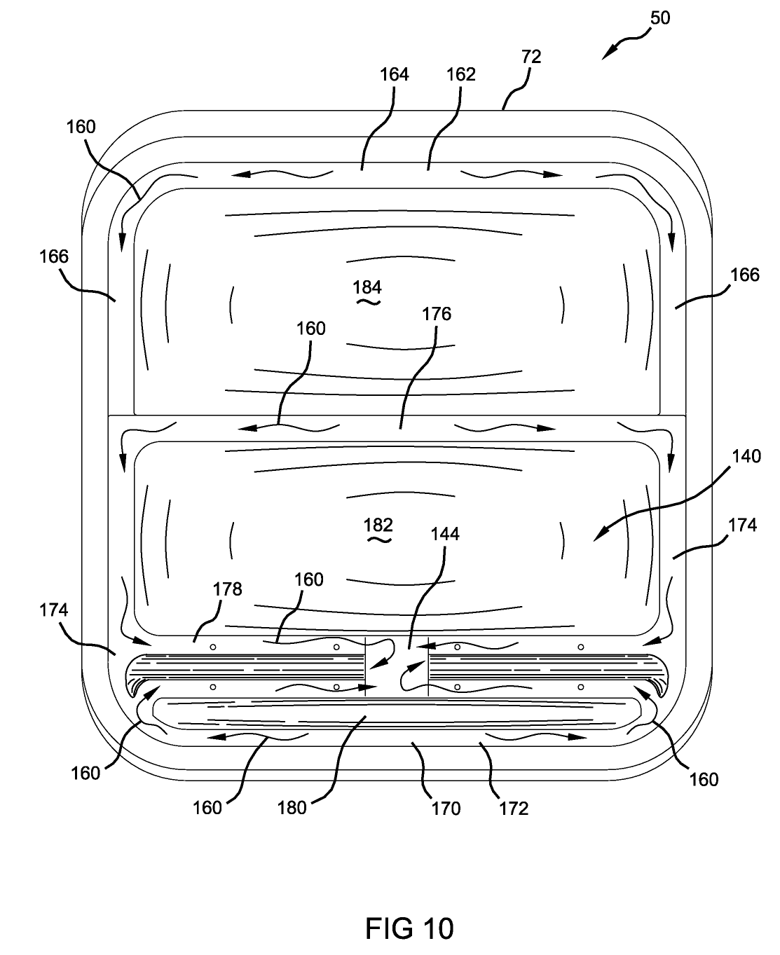

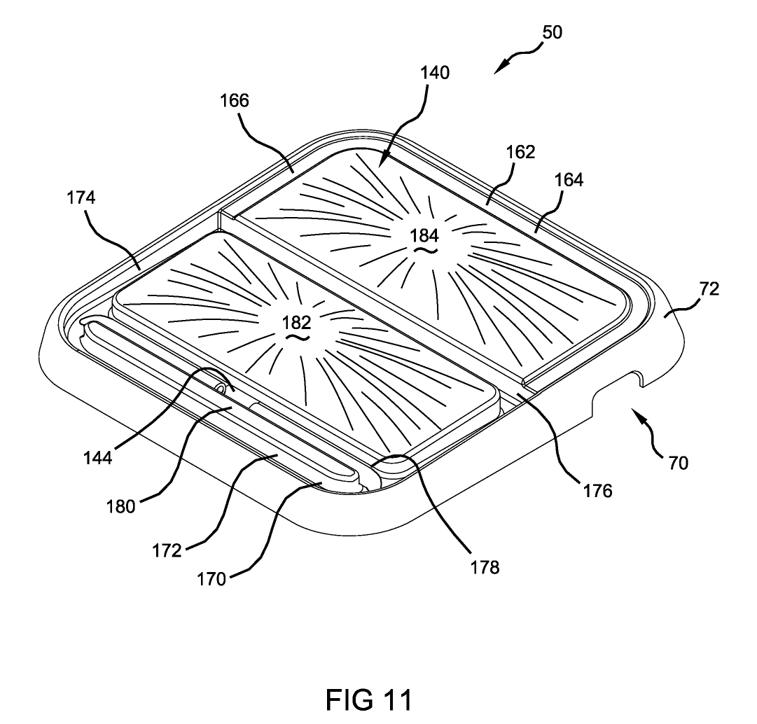

Referring now to FIGS. 10 and 11, the features of the water management system on top surface 140 of canopy 50 are shown. In particular, canopy 50 includes a rear peripheral channel 162 that extends along the rear portion of canopy 50 adjacent lip 72. Rear peripheral channel 162 includes a transversely extending section 164 and a pair of longitudinally extending sections 166 that direct water captured therein to basin 144. Canopy 50 includes a front peripheral channel 170 that extends along lip 72. Front peripheral channel 170 includes a transversely extending section 172 and a pair of longitudinally extending sections 174 that extend rearwardly from transverse section 172. Longitudinal sections 174 communicate with longitudinal sections 166 to receive water captured therein and flowing therethrough. Canopy 50 includes a first central transversely extending channel 176 that extends transversely between longitudinal sections 174 adjacent the rear ends thereof. Transverse channel 176 is contoured to direct water captured therein toward either longitudinal section 174. Canopy 50 includes a second transversely extending channel 178 that extends between longitudinal sections 174 forward of first transverse channel 176. Basin 144 is centrally located within second transverse channel 178. Second transverse channel 178 directs water captured therein and water from longitudinal sections 174 into basin 144.

Channels 162, 170, 176, 178 extend around and define first, second and third raised portions 180, 182, 184 that are sloped to direct water that lands thereon to channels 162, 170, 176, 178. Canopy 50 thereby directs water that lands thereon into channels 162, 170, 176, 178 which is routed to basin 144 via gravity. Water that enters basin 144 flows into cavities 150 of front strut members 52, as shown in FIG. 9, and is discharged through lower ends 90, as shown in FIG. 5A. Thus, the water management system is operable to capture water that lands on canopy 50 and direct the water through front strut members 52 to be discharged in a lower portion of golf car 22 thereby reducing the incidence of occupants of the golf car or items thereon, such as golf clubs, from getting wet.

Canopy 50 can be made of a plastic material, such as a thermoplastic. Additionally, canopy 50 can be molded with the above-described features and contours therein.

At the factory, golf car 22 can be assembled and canopy system 20 attached thereto. If desired, canopy system 20 can be attached with canopy 50 in the raised position by securing rear strut members 56 to support member 40. In the raised position, quality control and/or integrity checks can be made. When it is desired to ship golf car 22, canopy system 20 can be adjusted such that canopy 50 is in the lowered position, such as shown in FIG. 2. To move canopy system 20 from the raised position to a lowered position, rear strut members 56 are uncoupled from support member 40 and relocated and lowered into storage area 29 with lower ends 76 resting on floor 82 of storage area 29. During this movement, horizontal portions 120 of front strut members 52 rotate within recesses 122 and spring members 94 bend. The bending of spring members 94 and relative rotation of horizontal portions 120 within recesses 122 allow canopy 50 to move from the raised position to lowered position without uncoupling front strut members 52 from either golf car 22 or canopy 50 and without uncoupling rear strut members 56 from canopy 50. Golf car 22 can then be driven onto a transport container for shipment to desired destination. At the desired destination, golf car 22 can be driven off the transport container and canopy system 20 moved from the lowered position to the raised position by performing the opposite steps.

Thus, canopy system 20 facilitates the easy movement of canopy 50 between a raised position and a lowered position. The movement can be accomplished through the simple detachment of a few fasteners that couple rear strut members 56 to support member 40. These fasteners are easily accessible and do not require the removal of any other components of golf car 22. Additionally, this simple and easy process helps insure the integrity of canopy system 20 and golf car 22 at the desired destination point by providing limited opportunities for error in the movement of canopy system 20 between the shipped position and the raised position.

It should be appreciated that while the preceding description of canopy system 20 is made with reference to particular configurations and illustrations, such illustrations and configurations are merely exemplary in nature and that deviations can be made without departing from the spirit and scope of the present teachings. For example, the strut members 52, 56 can have different configurations to provide a desired aesthetic appearance and/or accommodate golf cars 22 of varying dimensions or configurations. Additionally, strut members 52, 56 can be non-tubular, such as square or solid members. Furthermore, strut members 52, 56 can be made of materials other than metal. Moreover, canopy 50 could have a collection basin that communicates with rear strut members 56 such that water is drained through rear strut members 56 and discharged at a desired lower location on the golf car. Additionally, canopy system 20 can include a front windshield that can move with the canopy system between the raised and lowered positions. Furthermore, canopy system 20 can include additional accessories, such as sand bottles, bag covers, bottle holders, and the like, by way of non-limiting example, and still move between the raised and lowered positions with the accessories attached thereto. Therefore, the front windshield and the accessories can be attached to the golf car at the factory and be folded into the shipping position along with the canopy system. Thus, the description herein is construed as merely exemplary in nature and variations can be made without departing from the scope of the present teachings.

Those skilled in the art can now appreciate from the foregoing description that the broad teachings can be implemented in a variety of forms. Therefore, while these teachings include particular examples, the true scope of the teachings should not be so limited since other modifications will become apparent to the skilled practitioner upon a study of the drawings, the specification and the following claims.

What is claimed is:

1. A golf car comprising:
a frame;
a seating area coupled to the frame; and
a canopy system moveable between a raised position and a lowered position, the canopy system including a canopy that covers at least a portion of the seating area in both the raised and lowered positions, and the canopy system being coupled to the frame in both the raised and lowered positions.

2. The golf car of claim 1, wherein the canopy system includes at least one front strut member that couples a front portion of the canopy to the frame, at least one rear strut member that couples a rear portion of the canopy to the frame, and at least one of the front and rear strut members remains coupled to the frame in both the raised and lowered positions.

3. The golf car of claim 2, wherein the at least one front strut member remains coupled to the frame in both the raised and lowered positions and the at least one rear strut member is coupled to the frame when the canopy is in the raised position and is uncoupled from the frame when the canopy is in the lowered position.

4. The golf car of claim 3, wherein the golf car includes a rear storage area and a lower end of the at least one rear strut member is supported in the rear storage area when the canopy is in the lowered position.

5. The golf car of claim 4, wherein an upper end of the at least one rear strut member is coupled to the canopy in both the raised and lowered positions and remains stationary relative to the canopy during movement between the raised and lowered positions.

6. The golf car of claim 3, wherein a lower end of the at least one rear strut member is removeably coupled to the frame with a pair of threaded fasteners when the canopy is in the raised position.

7. The golf car of claim 3, wherein the canopy system includes at least one hinge assembly that couples the at least one front strut member to the frame and allows the at least one front strut member to pivot relative to the frame when the canopy moves between the raised and lowered positions.

8. The golf car of claim 7, wherein the at least one hinge assembly includes a spring member that couples a lower end of the at least one front strut member to the frame and the spring member bends when the canopy moves between the raised and lowered position thereby allowing the at least one front strut member to remain coupled to the frame in both the raised and lowered positions.

9. The golf car of claim 8, wherein the spring member is a band of flexible metal.

10. The golf car of claim 8, wherein an upper end of the at least one front strut members is coupled to the front portion of the canopy and pivots relative to the canopy as the canopy moves between the raised and lowered positions.

11. The golf car of claim 1, wherein the seating area has a first seating height when the canopy is in the raised position, a second seating height when the canopy is in the lowered position, the second seating height is less than the first seating height, and the second seating height allows a user to operate the golf car when seated in the seating area.

12. The golf car of claim 11, wherein the second seating height is at least 22 inches.

13. The golf car of claim 2, wherein the at least one front strut member is a pair of front strut members and the at least one rear strut member is a pair of rear strut members.

14. The golf car of claim 1, wherein the canopy is a single rigid canopy that has a same shape in both the raised and lowered positions.

15. A golf car comprising:
a frame;
a seating area coupled to the frame;
a canopy covering at least a portion of the seating area and having only a single water collection basin on a top surface thereof such that all water captured on the top surface flows to the single water basin;
at least one front strut member coupling a front portion of the canopy to the frame; and
at least one rear strut member coupling a rear portion of the canopy to the frame,
wherein at least one of the front and rear strut members is in fluid communication with the single water basin such that water collected in the single water basin drains from the single water basin through an internal channel in the at least one of the front and rear strut members.

16. The golf car of claim 15, wherein the at least one front strut member is a pair of front strut members, the at least one rear strut member is a pair of rear strut members, and at least one of said front and rear pairs of strut members are in fluid communication with the single water basin such that water collected in the single water basin drains through internal channels in both strut members of the at least one pair that is in fluid communication with the single water basin.

17. The golf car of claim 14, wherein the top surface of the canopy includes a plurality of channels that direct water therein toward the single water basin.

18. The golf car of claim 14, wherein the canopy is moveable between a raised and lowered position.

19. A golf car comprising:
a frame;
a seating area coupled to the frame;
a canopy covering at least a portion of the seating area;
at least one front strut member attached to the canopy and coupling a front portion of the canopy to the frame; and
at least one rear strut member attached to the canopy and coupling a rear portion of the canopy to the frame,
wherein at least a portion of at least one of the front and rear strut members extends along a bottom surface of the canopy and is spaced apart therefrom thereby forming a grab handle that can be grasped by a user of the golf car.

20. The golf car of claim 19, wherein the grab handle is a portion of the at least one rear strut member.

21. The golf car of claim 20, wherein the canopy has a peripheral edge and a recess in the peripheral edge is aligned with the portion of the rear strut member that is spaced apart from the bottom surface of the canopy.

22. The golf car of claim 20, wherein the at least one rear strut member is a pair of rear strut members that extend along different sections of the bottom surface of the canopy and from two different grab handles.

23. A method comprising:
coupling a canopy to a frame of a golf car;
moving the canopy from a raised operable position covering at least a portion of a seating area of the golf car to a lowered shipping position, the canopy being coupled to the frame in both the raised and lowered positions and during movement therebetween;
shipping the golf car to a destination point with the canopy in the lowered shipping position; and
moving the canopy from the lowered shipping position to the raised operable position at the destination point.

24. The method of claim 23, wherein coupling the canopy to the frame includes:
attaching at least one front strut member to the canopy;
coupling the at least one front strut member to the frame;
attaching at least one rear strut member to the canopy;
coupling the at least one rear strut member to the frame, and
wherein moving the canopy between the raised and lowered positions includes maintaining at least one of the front and rear strut members coupled to the frame and attached to the canopy.

25. The method of claim 24, wherein moving the canopy from the raised operable position to the lowered shipping position includes maintaining the front strut member coupled to the frame and attached to the canopy and uncoupling the rear strut member from the frame while maintaining the rear strut member attached to the canopy.

26. The method of claim 25, wherein moving the canopy from the raised operable position to the lowered shipping position includes bending a spring member that couples the front strut member to the frame.

27. The method of claim 26, wherein moving the canopy from the raised operable position to the lowered shipping position includes rotating an upper end portion of the front strut member relative to the canopy while maintaining the upper end portion attached to the canopy.

28. The method of claim 25, wherein moving the canopy from the raised operable position to the lowered shipping position includes removing fasteners coupling a lower end of the rear strut member to the frame, moving the lower end into a storage area on a rear of the golf car and supporting the lower end with a surface of the storage area, and maintaining an upper end of the rear strut member stationarily attached to the canopy.

29. The method of claim 23, wherein moving the canopy from the raised operable position to the lowered shipping position includes maintaining a sufficient seating area height that enables a person to drive the golf car with the canopy in the lowered shipping position.
